(19) United States
(12) Patent Application Publication
(10) Pub. No.: US 2024/0407016 A1
(43) Pub. Date: Dec. 5, 2024

(54) ROBUST BWP APPROACHES TO MITIGATE THE IMPACT OF HIGH POWER NARROW-BAND INTERFERER

(71) Applicant: IDAC HOLDINGS, INC., Wilmington, DE (US)

(72) Inventors: Tariq Elkourdi, Belleville, NJ (US); Alpaslan Demir, East Meadow, NY (US); Sudhir Pattar, Mount Laurel, NJ (US); Philip Pietraski, Jericho, NY (US); Paul Russell, Lawrence, NJ (US); Joe Huang, Montville, NJ (US); Joseph Murray, Schwenksville, PA (US); Muhammad Fazili, Audubon, PA (US); Patrick Cabrol, Bayshore, NY (US)

(73) Assignee: INTERDIGITAL PATENT HOLDINGS, INC., Wilmington, DE (US)

(21) Appl. No.: 18/697,051

(22) PCT Filed: Sep. 29, 2022
(86) PCT No.: PCT/US2022/045229

§ 371 Date: Mar. 29, 2024

Related U.S. Application Data
(60) Provisional application No. 63/249,918, filed on Sep. 29, 2021.

(51) Int. Cl. H04W 74/08; H04W 72/0453; H04W 72/0457; H04W 74/0833

(52) U.S. Cl. CPC H04W 74/0866; H04W 72/0453; H04W 72/0457; H04W 74/0833

(57) ABSTRACT

Methods and apparatuses are described herein for robust bandwidth part (BWP) approaches to mitigate the impact of high power narrow-band interference. For example, a wireless transmit/receive unit (WTRU) may receive, from a base station (BS), configuration information indicating a plurality of initial bandwidth parts (BWPs). The plurality of initial BWPs may comprise a first initial BWP and a second initial BWP. The first initial BWP and the second initial BWP may be separated from each other in a frequency domain to avoid interference on at least one of the plurality of initial BWPs. The WTRU may send, based on failure to decode a transmission received in the first initial BWP, to the BS, an uplink transmission using the second initial BWP. The uplink transmission may include one or more preambles that are sent using a physical random access channel (PRACH).

### CROSS-REFERENCE TO RELATED APPLICATIONS

This application claims the benefit of U.S. Provisional Application No. 63/249,918, filed Sep. 29, 2021, the contents of which are incorporated herein by reference.

### BACKGROUND

The increasing demand for higher data rates in the last decade has intensified the need for very wide carrier bandwidth. In recent communication systems such as 5G, supporting different types of devices with different capabilities became a major design goal. Bandwidth parts (BWP), which is a subset of contiguous physical resource blocks (PRBs), may allow spectrum flexibility, both from bandwidth size and numerologies perspectives. However, due to the capability of recent cellular communication systems to operate on new higher frequencies, the interference between these systems and other military and civil operations such as aviation Radio Detection and Rangings (RADARs) became a major concern. Thus, methods and apparatuses that mitigate the impact of high power narrow-band interference are needed.

### SUMMARY

Methods and apparatuses are described herein for robust bandwidth part (BWP) approaches to mitigate the impact of high power narrow-band interference. For example, a wireless transmit/receive unit (WTRU) may receive, from a base station (BS), configuration information indicating a plurality of initial bandwidth parts (BWPs). The plurality of initial BWPs may comprise a first initial BWP and a second initial BWP. The first initial BWP and the second initial BWP may be separated from each other in a frequency domain to avoid interference on at least one of the plurality of initial BWPs. The WTRU may send, based on failure to decode a first transmission received in the first initial BWP, to the BS, an uplink transmission using the second initial BWP. The uplink transmission may include one or more preambles over a physical random access channel (PRACH).

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating example bandwidth part (BWP) types and sequence of events for BWPs switching;

FIG. 3 is a diagram illustrating example multiple non-overlapping BWPs;

FIG. 4A is a diagram illustrating an example procedure using multiple initial BWPs for uplink transmission;

FIG. 4B is a diagram illustrating another example procedure using multiple initial BWPs for downlink transmission;

FIG. 5 is a diagram illustrating an example configuration in a multiple overlaid (co-located) cell network to avoid interference;

FIG. 6 is a diagram illustrating an example multiple overlaid cell technique that is used as a network configuration embodiment to avoid interferer; and

FIG. 7 is a diagram illustrating an example single bandwidth-wide initial BWP.

### DETAILED DESCRIPTION

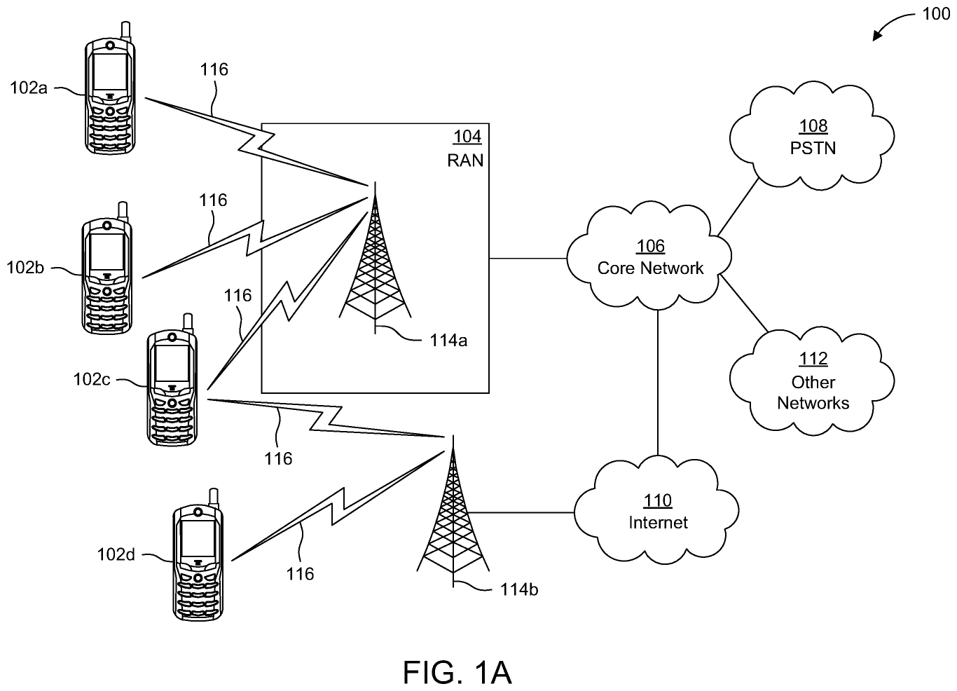

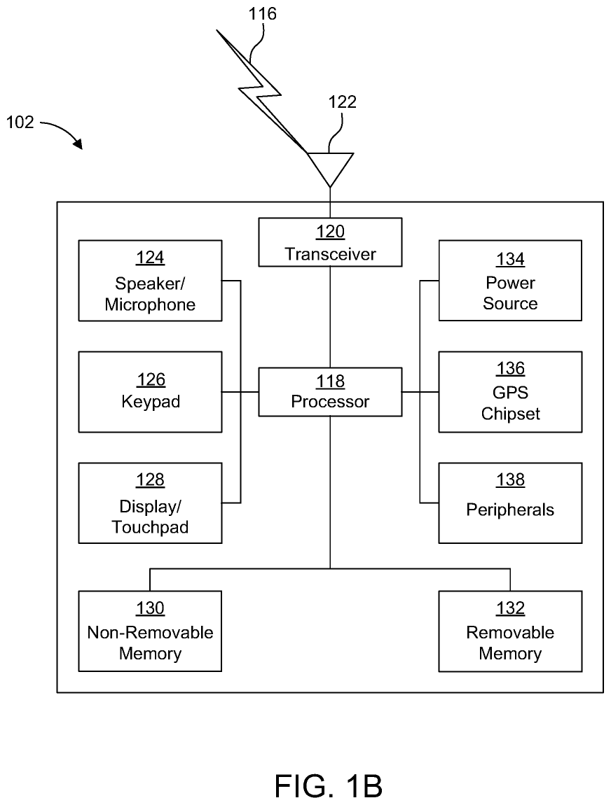

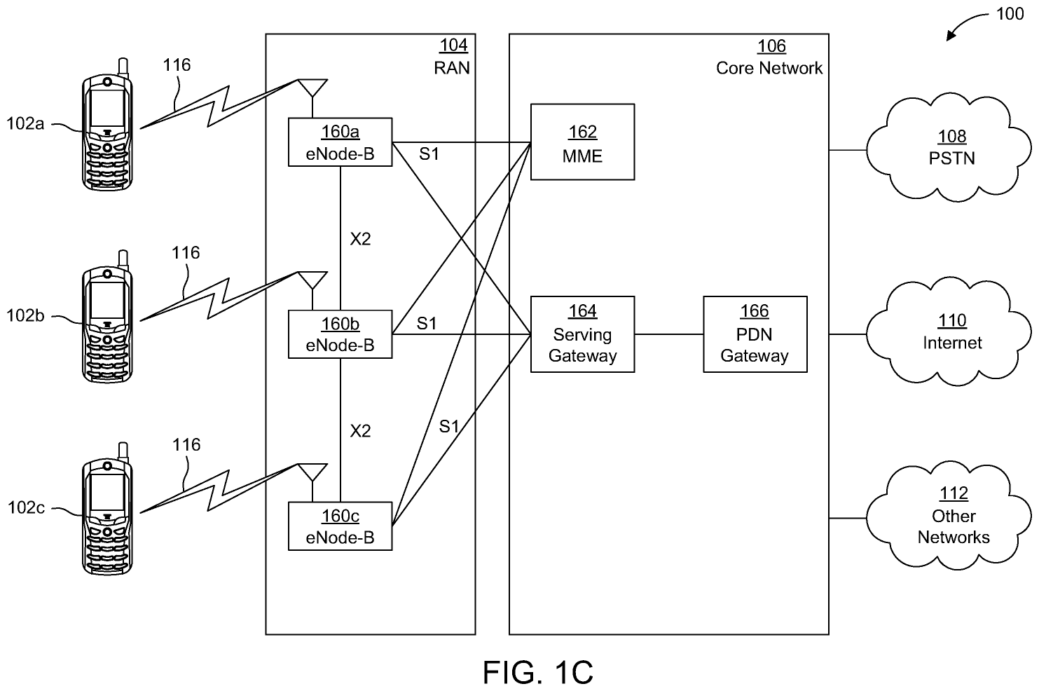

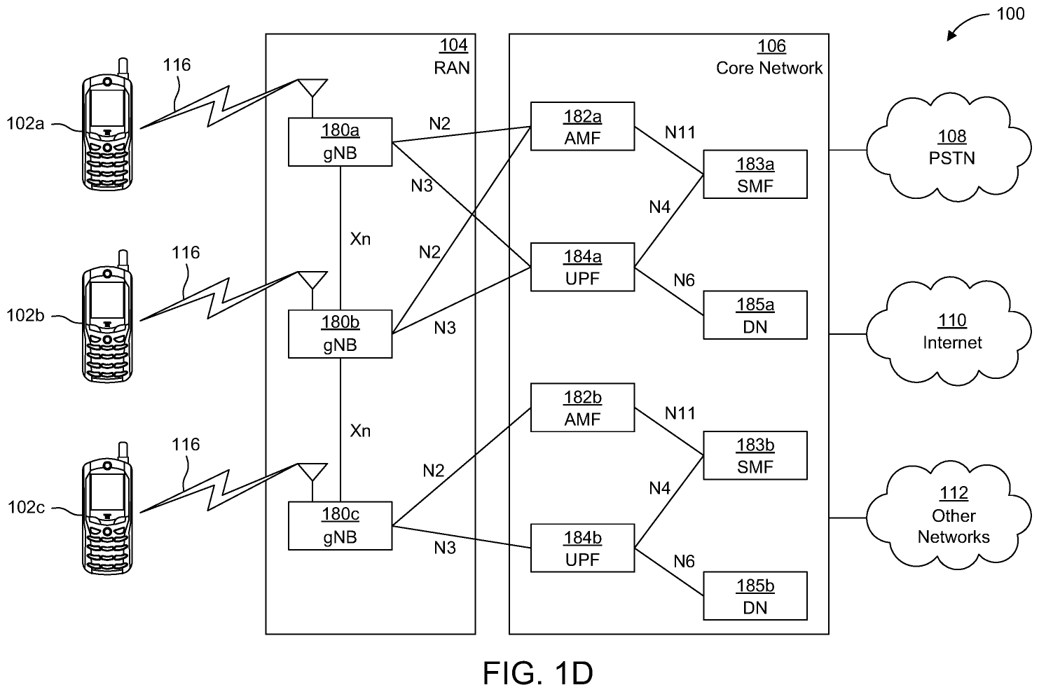

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users.

The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles.

Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.1 lac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c.

For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown).

The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### The Following Terminologies May be Used Throughout this Disclosure

3GPP Third Generation Partnership Project
5G 5th Generation
BW Bandwidth
BWP Bandwidth Part
CORESET Control Resource Set
CRC Cyclic Redundancy Check
CSI-RS Channel State Information Reference Signal
DCI Downlink Control Information
DMRS Demodulation Reference Signal
gNB NR NodeB
MAC Medium Access Control
NR New Radio
OFDM Orthogonal Frequency Division Multiplexing
PDCCH Physical Downlink Control Channel
PDSCH Physical Downlink Shared Channel
PHY Physical Layer
RADAR Radio Detection and Ranging
RB Resource Block
RE Resource Element
RRC Radio Resource Control
RV Redundancy Version
SPS Semi-Persistent Scheduling
UE User Equipment
NSA Non-Stand Alone
SSB Synchronization Signal Block
PSS Primary Synchronization Signal
SSS Secondary Synchronization Signal
MIB Master Information Block
PBCH Physical Broadcast Channel
SIB1 System Information Block 1
CRBO Common Resource Block 0
SS_PBCH Synchronization and Broadcast Channel combination
RB Resource Block (12 REs over a symbol duration)
SCS Subcarrier spacing
PRACH Physical Random Access Channel
SI System Information

The increasing demand for higher data rates in the last decade has intensified the need for very wide carrier bandwidth. In recent communication systems such as 5G, supporting different types of devices with different capabilities became a major design goal. Bandwidth parts may allow spectrum flexibility, both from bandwidth size and numerologies perspectives.

A bandwidth part (BWP) is a subset of contiguous physical resource blocks (PRBs), from a contiguous set of common resource blocks (CRBs), for a given numerology on a given carrier. In an example, a WTRU can have a maximum of four BWPs for downlink (DL) and a maximum of four BWPs for uplink (UL), but only one BWP can be active at any given time. In case that the WTRU is configured with supplementary uplink, the WTRU can be configured with up to four additional bandwidth parts (BWPs). The bandwidth part (BWP) allows for WTRU power saving by having WTRU monitor only the active BWP which is likely much less than the cell bandwidth. There are different types of BWPs such as initial BWP, default BWP, dedicated BWP and first active BWP.

The initial BWP may be used for initial access and broadcast signals before Radio Resource Control (RRC) connection is established. The initial BWP is common to all WTRUs. It may have index zero and may be denoted as BWP #0. After downlink synchronization via synchronization signal block (SSB), the WTRU may proceed to read System Information Block (e.g., SIB1) which carries information regarding the initial BWP.

Such information may include frequency domain location and size in physical resource blocks (PRBs) such that it includes all CORESET #0.

Default BWP may be used during WTRU inactivity periods. The network (e.g., BS) may provide the WTRU with bwp-InactivityTimer which is the WTRU inactivity duration in millisecond after the WTRU switches to the default bandwidth part. Upon expiration of bwp-InactivityTimer, the WTRU may switch to the default BWP for power saving. Higher layer parameter defaultDownlinkBWP-ld may indicate the ID of the downlink bandwidth part to be used upon expiry of the BWP inactivity timer. It may be configured in ServingCellConfig as the default BWP from the set of configured BWPs. If a default DL BWP is not provided by defaultDownlinkBWP-Id, the WTRU may use initial BWP as the default BWP.

Dedicated BWP may be used for uplink and downlink data transmission. The network may configure the WTRU with dedicated BWPs via dedicated RRC signaling.

A WTRU may switch to the first active BWP upon RRC (re)configuration or MAC activation of secondary cell in Nonstand Alone (NSA) architecture.

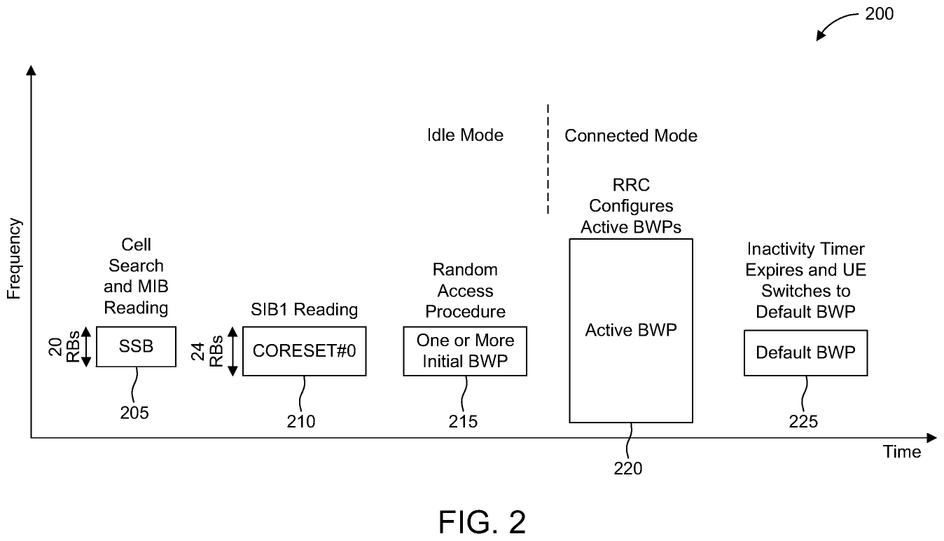

FIG. 2 illustrates example bandwidth part (BWP) types and sequence of events 200 for BWPs switching, which may be used in combination with any of other embodiments described herein. As illustrated in FIG. 2, a WTRU may perform cell search based on synchronization signal block (SSB) 205 when entering a system. The SSB 205 may comprise the primary synchronization signal (PSS), the secondary synchronization signal (SSS), and the physical broadcast channel (PBCH). The PBCH may carry the Master Information Block (MIB), which includes a small amount of information that the WTRU needs in order to be able to acquire the remaining system information broadcast by the network. For example, PBCH/MIB may provide information about the numerology (e.g., subcarrier spacing) used for SIB1 transmission as well as the search space and corresponding CORESET (e.g., CORESET #0) used for scheduling of SIB1. The WTRU may then monitor the scheduling of SIB1 and read the SIB1 within the CORESET #0 210. The SIB1 may provide the information, for example, one or more initial BWPs 215, that the WTRU needs in order to carry out an initial random access.

Once connected, the WTRU may be configured with active BWP(s) 220 via RRC (re)configuration. The active BWP(s) may comprise up to four active uplink BWPs and up to four active downlink BWPs for each serving cell. Once the inactivity timer of the WTRU expires, the WTRU may switch to the default BWP 225 for power saving.

The random access procedure in FIG. 2 may be a 4-step procedure, 2-step procedure or the like. In the 4-step random access procedure, at step 1, the WTRU may send, to a BS, a preamble or PRACH transmission. At step 2, the WTRU may receive, from the BS, a random-access response (RAR) over PDSCH indicating the reception of the preamble and providing a timing alignment command and a scheduling grant for message 3. At step 3, the WTUR may send message 3 transmission over PUSCH, providing the device identity to facilitate contention resolution. At step 4, the WTRU may receive message 4 over PDSCH to resolve collision (i.e., contention resolution). In the 2-step random access procedure, at step A, a WTRU may send, to a BS, a preamble/PRACH transmission together with a PUSCH data transmission, which are jointly referred to as message A. At step B, the WTRU may receive a single downlink transmission (referred to as message B) over PDSCH indicating reception of message A, providing timing alignment and resolving any collision that may have occurred in step A.

Bandwidth part(s) (BWP(s)) may be WTRU specific which means that the network (e.g., BS) may decide the size and location of the BWP(s) for each WTRU. For each DL BWP or UL BWP, the network may provide the WTRU with a subcarrier spacing (SCS), a cyclic prefix, downlink and/or uplink BWP index, bandwidth part starting PRB location and number of contiguous RBs, and the like.

Bandwidth part configuration may be divided into two types: BWP-common and BWP-dedicated.

In the configuration of BWP-common, the parameters may be cell specific which means that they are common to all WTRUs within the cell. For DL BWPs. These parameters may include, but are not limited to, frequency domain location, size in RBs, subcarrier spacing, cyclic prefix, PDCCH and PDSCH cell specific parameters. For UL BWPs, parameters may include, but are not limited to, random access, PUCCH and PUSCH configuration.

The configuration of BWP-dedicated may include WTRU specific parameters. For DL BWPs, such parameters may include, but are not limited to, PDCCH, PDSCH, semi-persistent scheduling and radio link monitoring configuration. For UL, parameters may include, but are not limited to, PUSCH, PUSCH, SRS, configured grant and beam failure recovery configuration.

Bandwidth parts used for data transmission may include both types, common and dedicated parameters. However, initial BWP(s) can be configured to include cell specific only parameters or cell specific and WTRU specific parameters. Initial BWP(s) configured with common parameters only may be used for initial access. An initial BWP configured with both cell specific and WTRU specific parameters can be used for initial access as well as data transmission. The WTRU may obtain cell specific parameters via SIB1 and/or WTRU specific parameters via RRC configuration messages.

For FDD systems, DL BWPs and UL BWPs may be configured separately. For TDD, DL BWP and UL BWP may be the same. They may have the same center frequency but may have different bandwidths.

Different bandwidth part switching are described herein. The different BWP switching types may include, but are not limited to, RRC signaling switching, DCI switching, inactivity timer switching, and MAC entity initiated switching.

RRC signaling switching may be the only type that allows the network to configure a new BWP. The switching delay involved in this type may be typically large and comprise delay to process RRC procedure and delay for WTRU to complete the BWP switch.

DCI switching may allow the WTRU to switch between two pre-configured BWPs via DCI format 1_1 and 0_1. The BWP field in DCI format 0_1/1_1 may have a bitwidth of 0-2 as indicated in Table 1. There may be two types of switch delay requirements for each subcarrier spacing depending on WTRU capability as shown in Table 2.

TABLE 1
BWP indicator field in DCI format 0_1/1_1

| # of RRC configured | | | |
|---|---|---|---|
| BWPs, excluding | Bitwidth of BWP | BWP indicator in | |
| initial BWP | indicator field | DCI 0_1/1_1 | BWP Id |
| 0 | 0 | Absent | 0 |
| 1 | 1 | 0, 1 | 0, 1 |
| 2 | 2 | 00, 01, 10 | 0, 1, 2 |
| 3 | 2 | 00, 01, 10, 11 | 0, 1, 2, 3 |
| 4 | 2 | 00, 01, 10, 11 | 1, 2, 3, 4 |

For inactivity timer switching, the WTRU may switch from the active BWP to a default BWP after the expiration of a certain timer (e.g., inactivityTimer). The BWP inactivity timer-based switch delay requirement may be indicated in Table 2.

TABLE 2
DCI and Inactivity timer switching delay requirements.

| | |
|---|---|
| Subcarrier | BWP switch delay requirement (slots) |

| spacing (kHz) | Type 1 | Type 2 |
|---|---|---|
| 15 | 1 | 3 |
| 30 | 2 | 5 |
| 60 | 3 | 9 |
| 120 | 6 | 18 |

MAC entity initiated switching may happen upon initiation of Random Access procedure. It may allow configuring a new BWP. It may depend upon whether or not PRACH occasions are configured for the active UL BWP.

With the capability of recent cellular communication systems to operate on new higher frequencies, the interference between these systems and other military and civil operations such as aviation RADARs became a major concern. For example, C-band is currently in its initial phases of 5G deployment and is mainly used by low power satellites. As 5G deployment in C-band expands, harmful interferences from 5G transmissions could pose a significant risk to the operation of RADARs. For instance, aviation uses certain technologies to measure the distance between an aircraft and the surface of the ground and could end up being compromised by interference from 5G. On the other hand, interference from the RADAR could hinder the performance of 5G systems which rely heavily on shorter delays and higher throughputs.

In 5G, initial BWP may include, but are not limited to, SSB transmission, system information exchange, PRACH, and paging related signaling. When a narrow-band high power interferer such as RADAR operates in a band that overlaps with the initial BWP, the WTRUs may not be able to detect the synchronization signals, decode the system information and paging or access the network due to high level of interference. In other words, not only emerging WTRUs won't be able to access the network, but also attached WTRUs won't read System Information updates and paging messages and perform RACH, if needed, over the initial BWP.

Bandwidth parts may allow spectrum flexibility by dynamically switching WTRUs between different band sizes and locations depending on the WTRU activity and to optimize scheduling. This flexibility may be exploited to provide interference avoidance. A BWP configuration, for example, may comprise a single initial BWP and possibly multiple dedicated BWPs. Initial BWP may be used by a WTRU to perform initial access procedure. Interference to the essential signals in the initial BWP can be detrimental to the network performance. The embodiments below describes changes to the initial BWP to avoid overlapping of these important signals with high power interferer signals.

First, multiple and simultaneous initial BWPs may be allowed to exist per cell. The simultaneous initial BWPs may ideally be allocated at the extreme edges of the carrier bandwidth to ensure non-overlapping between interfered and non-interfered bands. A SIB1 messaging may indicate the location of the multiple simultaneous initial BWPs. If the WTRU fails to decode information in first initial BWP, it may try to decode the same in the other simultaneous initial BWP(s). The multiple, simultaneous initial BWPs may refer to initial BWPs that are separately/differently located in the frequency domain but exists at the same time (or same time frame, subframe, duration, period, or symbols) in the time domain. In some embodiments, the multiple initial BWPs may be separately/differently located in the frequency domain, but exists/configured in an overlapped/different time (or overlapped/different time frame, subframe, duration, period, or symbols) in the time domain, For example, a WTRU may be configured with a first initial BWP and later configured with a second initial BWP via RRC (re)configuration.

Second, a network configuration may split the available carder bandwidth to multiple carriers, each with its own non-overlapping band. These multiple bands may be assigned to overlaid cells to provide near identical coverage. Here, the basic channel quality measurement and reporting may be done by the WTRU and reported to the BS (e.g., gNB) for inter-frequency handover. WTRUs may experience different levels of channel quality degradation due to the impact of interference. Some of which may be able to combat it via HARQ and link adaptation techniques but other may opt to handover to a different cell as the retransmission and link adaptation simply become not feasible.

Finally, a single RRC configured initial BWP may be configured with dynamic shifting of SSB and CORESET #0 to avoid narrow-band high power interferers. The idea is to configure this initial BWP to be as wide in the frequency domain as possible (e.g., ideally spanning the entire cell BW) to allow for greater separation when shifting essential signals. Larger separation in the frequency domain may enable better narrow band interferer avoidance.

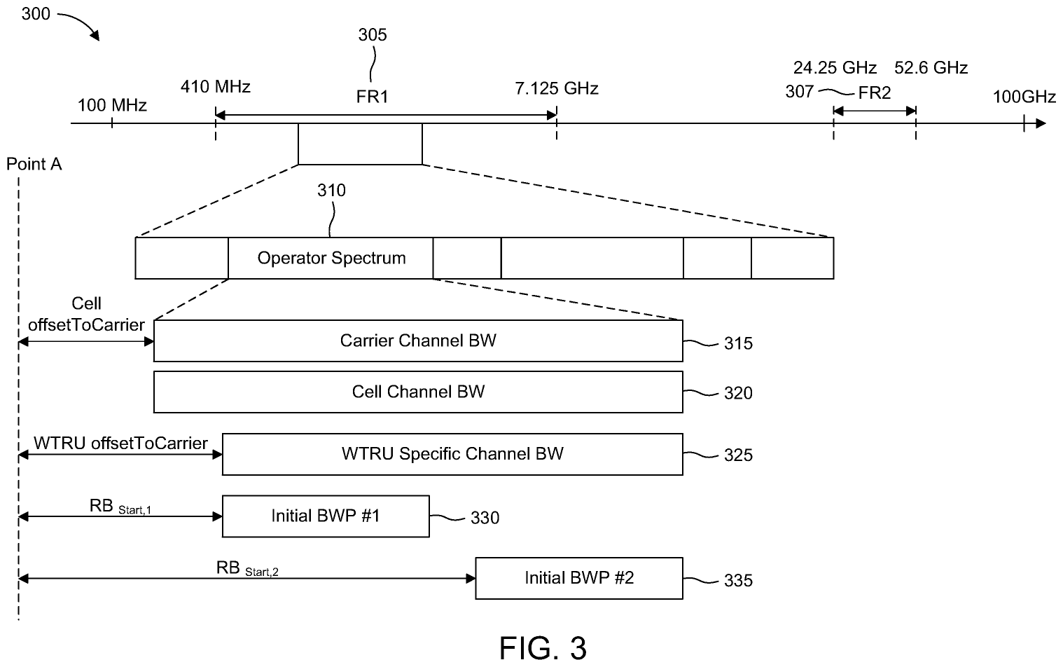

Embodiments for multiple simultaneous initial BWPs are described herein. FIG. 3 illustrates example multiple non-overlapping initial bandwidth parts (BWPs), which may be used in combination with any of other embodiments described herein. As illustrated in FIG. 3, in a frequency domain that comprises FR1 305 (e.g., a lower frequency band) and FR2 307 (e.g., a higher frequency band). The FR1 305 may include an operator spectrum 310 where the carrier channel BW 315 or the cell channel BW 320 exists. Within the carrier channel BW 315 or the cell channel BW 320, the WTRU specific channel BW 325 may include multiple initial BWPs: initial BWP #1 330 and initial BWP #2 335.

Simultaneous operation over multiple initial BWPs 330, 335 may overcome the impact of high power interference on channels and signals such as synchronization signals. As illustrated in FIG. 3, these initial BWPs can be defined to reside, for example, on opposite ends of the WTRU supported spectrum. This may allow a greater separation between initial BWPs 330, 335 to minimize the chances that both are interfered at the same time. The initial BWPs 330, 335 can be either cell-specific or RRC configured for specific WTRUs. It is noted that the simultaneously operating on two or more initial BWPs 330, 335 may avoid longer delays associated with redefining a single initial BWP via RRC messaging. Majority of the delay in this case may come from processing for RRC procedure.

Although, decoding SIB1 may imply that the first initial BWP (e.g., initial BWP #1 330) is not interfered, since the WTRU assumes an initial BWP of the same frequency band as CORESET #0, the first initial BWP (e.g., initial BWP #1 330) may still become interfered in a different or later time due to the changing characteristics of the RADAR interference. This may impact WTRUs trying to regain access to the network via the first initial BWP (e.g., initial BWP #1 330). In addition, waiting for an updated configuration from SIB1, which may also be interfered, may not be an efficient approach. Moreover, during periods of WTRU inactivity, the WTRU may switch to a default BWP which may have the same frequency range as the initial BWP (i.e., defaultDownlinkBWP-Id set to #0). If the default BWP is impacted by interference, the WTRU may not be able to regain access to the network. The configuration of two (or more) simultaneous BWPs may resolve these issues. For example, the WTRU may perform random access using the first initial BWP (e.g., initial BWP #1 330). If random access is successful, the WTRU may switch to connected mode and start using the active BWP for data transmission. If random access fails due to interference, the WTRU may proceed to perform random access via the second initial BWP (e.g., initial BWP #2 335) and so on.

From a WTRU's perspective, for the case in which a WTRU specific RRC configured BWP does not include one or both bandwidths of the initial BWPs, support of BWP operation without bandwidth restriction may be needed. Support of this capability may be needed for WTRU RF tuning and may be signaled to the BS (e.g., gNB) via parameter bwp-WithoutRestriction as part of the WTRU capability message as shown below.

BandNR ::= SEQUENCE {

| | | |
|---|---|---|
| bwp-WithoutRestriction | ENUMERATED {supported} | OPTIONAL, |
| bwp-SameNumerology | ENUMERATED {upto2, upto4} | OPTIONAL, |
| bwp-DiffNumerology | ENUMERATED {upto4} | OPTIONAL, |

...
}

The bandwidth part configuration may be divided into uplink/downlink and common/dedicated parameters. One or more initial BWPs can be configured in UplinkConfigCommon, UplinkConfigCommonSIB and/or UplinkConfig for dedicated initial BWP as shown below. The WTRU may derive the initial BWPs based on information such as locationAndBandwidth. The WTRU may use this parameter to derive the frequency location and bandwidth of the initial BWP. The following describes BWP configuration to support simultaneous initial BWPs in the uplink. While the WTRU is in idle mode, UplinkConfigCommonSlB in SIB1 may be used to convey initial BWP information. While the WTRU is in connected mode, RRC (re)configuration messages may include one or more parameters such as UplinkConfigCommon and UplinkConfig to convey initial BWP information.

UplinkConfigCommon:

| | |
|---|---|
| UplinkConfigCommon ::= | SEQUENCE {. |
| frequencyInfoUL | FrequencyInfoUL |
| initialUplinkBWPs | SEQUENCE (SIZE(1..maxNrofULInitBWPs)) OF BWP-UplinkCommon OF |

```
    BWP-Uplink
}
maxNrofULInitBWPs INTEGER ::= INTEGER (1-4)
BWP-Uplink ::=  SEQUENCE {
    bwp-Id  BWP-Id,
```

| | |
|---|---|
| bwp-common | BWP-UplinkCommon |
| bwp-Dedicated | BWP-UplinkDedicated |

...
}

| BWP-UplinkCommon ::= | SEQUENCE { | |
|---|---|---|
| genericParameters | BWP, | |
| rach-ConfigCommon | SetupRelease { RACH-ConfigCommon } | OPTIONAL, |
| pusch-ConfigCommon | SetupRelease { PUSCH-ConfigCommon } | OPTIONAL, |
| pucch-ConfigCommon | SetupRelease { PUCCH-ConfigCommon } | OPTIONAL, |

...
}
BWP ::= SEQUENCE {

| | |
|---|---|
| locationAndBandwidth | INTEGER (0..37949), |
| subcarrierSpacing | SubcarrierSpacing, |
| cyclicPrefix | ENUMERATED { extended } |

}

| BWP-UplinkDedicated ::= | SEQUENCE { | |
|---|---|---|
| pucch-Config | SetupRelease { PUCCH-Config } | OPTIONAL,--Need M |
| pusch-Config | SetupRelease { PUSCH-Config } | OPTIONAL,--Need M |
| configuredGrantConfig | SetupRelease { ConfiguredGrantConfig } | OPTIONAL,--Need M |
| srs-Config | SetupRelease { SRS-Config } | OPTIONAL,--Need M |

```
    beamFailureRecoveryConfig  SetupRelease { BeamFailureRecoveryConfig } OPTIONAL,--Need
    M
      ...
}
UplinkConfigCommonSIB
```

| | |
|---|---|
| UplinkConfigCommonSIB ::= | SEQUENCE { |
| frequencyInfoUL | FrequencyInfoUL-SIB, |
| initialUplinkBWPs | SEQUENCE (SIZE(1..maxNroflnitBWPs)) OF BWP-Uplink, |
| timeAlignmentTimerCommon | TimeAlignmentTimer |

}
UplinkConfig
UplinkConfig ::= SEQUENCE {

| | |
|---|---|
| initialUplinkBWPs | SEQUENCE (SIZE (1..maxNrofinitBWPs)) OF BWP-Uplink, |
| uplinkBWP-ToReleaseList | SEQUENCE (SIZE (1..maxNrofBWPs)) OF BWP-OPTIONAL,-- Need |

N

| | |
|---|---|
| uplinkBWP-ToAddModList | SEQUENCE (SIZE (1..maxNrofBWPs)) OF BWP-Uplink OPTIONAL, |
| firstActiveUplinkBWP-Id | BWP-Id OPTIONAL, -- Need R |
| pusch-ServingCellConfig | SetupRelease { PUSCH-ServingCellConfig } OPTIONAL, |

...
}

Initial downlink BWP can be configured in DownlinkConfigCommon, DownlinkConfigCommonSlB and/or ServingCellConfig. The following describes BWP configuration to support simultaneous initial BWPs in the downlink.

DownlinkConfigCommon

| | |
|---|---|
| DownlinkConfigCommon := | SEQUENCE {. |

frequencyInfoDL

| | |
|---|---|
| initialDownlinkBWPs | SEQUENCE (SIZE (1..maxNroflnitBWPs)) OF BWP-DownlinkCommon |

OF BWP-Downlink
}
DownlinkConfigCommonSIB
DownlinkConfigCommonSIB ::= SEQUENCE {

| | |
|---|---|
| frequencyInfoDL | FrequencyInfoDL-SIB, |
| initialDownlinkBWPs | SEQUENCE (SIZE (1..maxNrofDLInitBWPs)) OF BWP- |

downlinkCommon OF BWP-Downlink,

| | |
|---|---|
| bcch-Config | BCCH-Config, |
| pcch-Config | PCCH-Config, |

...
}
maxNrofDLInitBWPs INTEGER ::= INTEGER (1-4)
ServingCellConfig

| | |
|---|---|
| ServingCellConfig ::= | SEQUENCE { |

tdd-UL-DL-ConfigurationDedicated TDD-UL-DL-ConfigDedicated OPTIONAL, -- Cond TDD

| | |
|---|---|
| initialDownlinkBWPs | SEQUENCE (SIZE (1..maxNroflnitBWPs)) OF BWP- |

downlinkDedicated OF BWP-Downlink,

| | |
|---|---|
| downlinkBWP-ToReleaseList | SEQUENCE (SIZE (1..maxNrofBWPs)) OF BWP-Id OPTIONAL, |
| downlinkBWP-ToAddModList | SEQUENCE (SIZE (1..maxNrofBWPs)) OF BWP-Downlink |

OPTIONAL

| | |
|---|---|
| firstActiveDownlinkBWP-Id | BWP-Id OPTIONAL, -- Need R |
| bwp-InactivityTimer | ENUMERATED {ms2, ms3, ms4, ms5, ms6, ms8, ms10, ms20, ms30, |

ms40,ms50, ms60, ms80 ms100, ms200, ms300, ms500, ms750, ms1280, ms1920, ms2560, spare 10, spare9,
spare8, spare7, spare6, spare5, spare4, spare3, spare2, spare1 } OPTIONAL

| | |
|---|---|
| defaultDownlinkBWP-Id | BWP-Id OPTIONAL, -- Need M |
| uplinkConfig | UplinkConfig OPTIONAL, -- Cond ServCellAdd-UL |
| supplementaryUplink | UplinkConfig OPTIONAL, -- Cond ServCellAdd-SUL |
| pdsch-ServingCellConfig | SetupRelease { PDSCH-ServingCellConfig } OPTIONAL, -- Need M |
| csi-MeasConfig | SetupRelease { CSI-MeasConfig } OPTIONAL, -- Need M |
| carrierSwitching | SetupRelease { SRS-CarrierSwitching} OPTIONAL, -- Need M |
| sCellDeactivationTimer | ENUMERATED {ms20, ms40, ms80, ms160, ms200, ms240, ms320, |

ms400, ms480, ms520, ms640, ms720, ms840, ms1280, spare2,spare1} OPTIONAL, -- Cond
ServingCellWithoutPUCCH

| | |
|---|---|
| crossCarrierSchedulingConfig | OPTIONAL,-- Need M |
| tag-Id | TAG-Id, |
| ue-BeamLockFunction | ENUMERATED {enabled} OPTIONAL, Need R |
| pathlossReferenceLinking | ENUMERATED {pCell, sCell} OPTIONAL --Cond SCellOnly |

}
BWP-Downlink := SEQUENCE {

| | |
|---|---|
| bwp-Id | BWP-Id, |
| bwp-Common | BWP-DownlinkCommon |
| bwp-Dedicated | BWP-DownlinkDedicated |

...
}

| | |
|---|---|
| BWP-DownlinkCommon ::= | SEQUENCE { |

```
  genericParameters BWP,
  pdcch-ConfigCommon SetupRelease { PDCCH-ConfigCommon }
  pdsch-ConfigCommon SetupRelease { PDSCH-ConfigCommon }
...
}
BWP-DownlinkDedicated := SEQUENCE {
```

| | |
|---|---|
| pdcch-Config | SetupRelease { PDCCH-Config } |
| pdsch-Config | SetupRelease { PDSCH-Config } |
| sps-Config | SetupRelease { SPS-Config } |

```
  radioLinkMonitoringConfig SetupRelease { RadioLinkMonitoringConfig }
  ...
}
```

Embodiments for a WTRU's support of multiple simultaneous initial BWPs are described herein. The WTRU may inform the network of its multiple simultaneous initial BWPs supportability. The network may optionally enable or disable this feature for the WTRU based on the WTRU capability and the network's requirement. The WTRU may inform the network of its capability via the information message as shown in Table 3 below.

TABLE 3
An example information message for multiple
initial BWPs supportability

| | | | FDD − TDD | FR1 − FR2 |
|---|---|---|---|---|
| Definitions for parameters | Per | M | DIFF | DIFF |
| multipleInitBWPs | UE | Yes | No | No |
| Indicates whether the UE may | | | | |
| support multiple simultaneous | | | | |
| initial BWPs. | | | | |

If the WTRU may indicate that it does not support this feature, the network may use a configuration such as a single initial BWP.

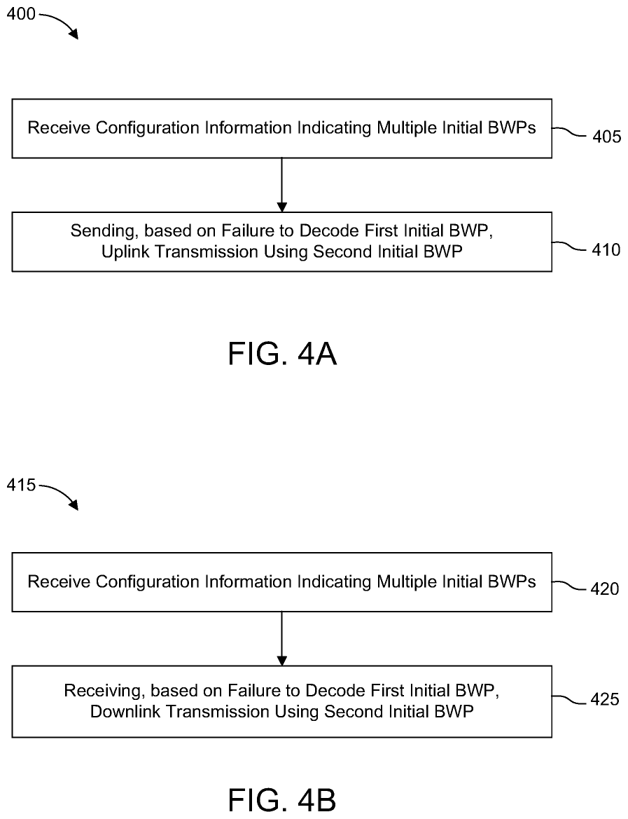

FIG. 4A is a diagram illustrating an example procedure 400 using multiple initial BWPs for uplink transmission, which may be used in combination with any of other embodiments described herein. At step 405, a WTRU may receive, from a base station (BS), configuration information that indicates multiple initial BWPs. The configuration information may be included in system information message(s) such as SIB1, RRC (re)configuration message(s), or the like. The multiple initial BWPs may include a first initial BWP and a second initial BWP. The first initial BWP may indicate a first set of resource blocks (RBs) in the frequency domain. The second initial BWP may indicate a second set of resource blocks (RBs) in the frequency domain. The first set of RBs and the second set of RBs may be located separately in the frequency domain to avoid interference on at least one of the multiple initial BWPs. The first initial BWP may be a first initial uplink BWP or a first initial downlink BWP. For paired spectrum or Frequency Division Duplex (FDD), uplink and downlink BWPs (including the initial uplink BWP and initial downlink BWP) may be configured separately and independently for each WTRU-specific servicing cell for the WTRU. For unpaired spectrum or Time Division Duplex (TDD), a uplink BWP (including the initial uplink BWP) and a downlink BWP (including the initial downlink BWP) may be jointly configured as a pair, with the restriction that the UL and DL BWPs of the UL/DL BWP pair share the same center frequency but may include different bandwidths for each WTRU-specific serving cell for the WTRU. At step 410, the WTRU may send, based on failure to decode the first initial BWP, an uplink transmission to the BS using the second initial BWP. The uplink transmission may comprise one or more preambles over a physical random access channel (PRACH). For the initial access, the WTRU may attempt one or more preamble transmissions with increasing power to adapt to different pathloss and interference environments during the normal operation.

For each serving cell, the maximal number of uplink/downlink BWP configurations is: (1) four uplink BWPs and four downlink BWPs for the paired spectrum or FDD; and (2) four uplink/downlink BWP pairs for the unpaired spectrum or TDD.

FIG. 4B is a diagram illustrating an example procedure 415 using multiple initial BWPs for downlink transmission, which may be used in combination with any of other embodiments described herein. The step 420 is substantially similar to the step 405 described above. Thus, details of the step 420 are not described herein for brevity. At step 425, the WTRU may receive, based on failure to decode the first initial BWP, a downlink transmission from the BS using the second initial BWP. The downlink transmission may include, but are not limited to, a random access response (RAR), message 4 in a 4-step random access procedure and message B in a 2-step random access procedure. Similar to the first initial BWP described above, the second initial BWP may be a second initial uplink BWP or a second initial downlink BWP.

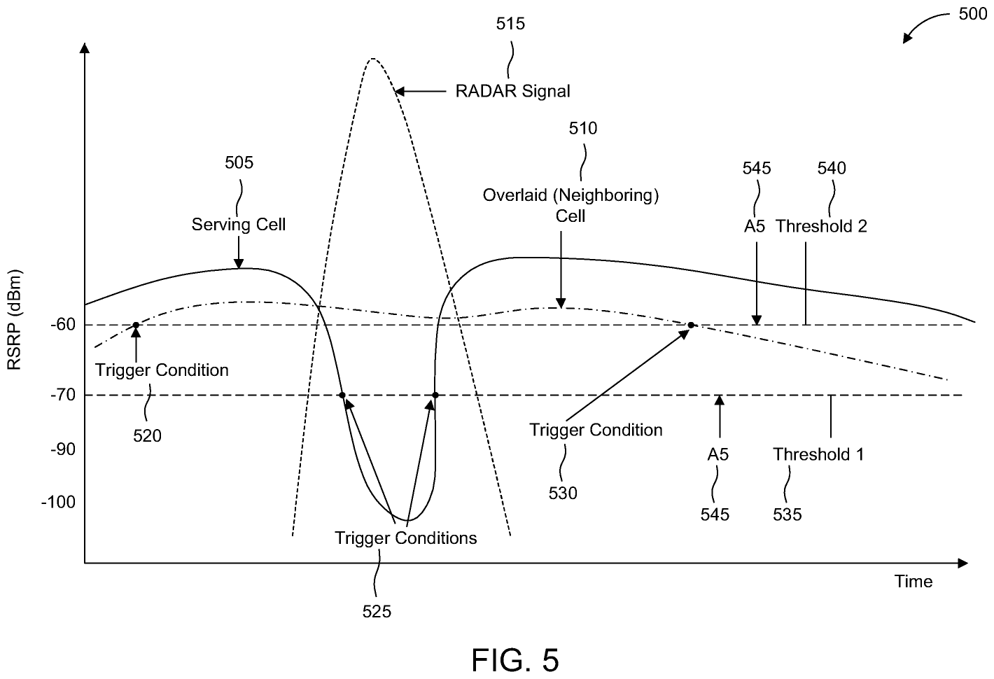

Embodiments for dynamic multi overlaid (co-located) cell network configuration are described herein. FIG. 5 illustrates an example scenario 500 in a multiple overlaid (co-located) cell network to avoid interference, which may be used in combination with any of other embodiments described herein. In this example scenario 500, a serving cell 505 may become worse than threshold 1 535 and a neighbor (overlaid) cell 510 may become better than threshold 2 540. Here, all other offsets and Hystereses are assumed to be zero for simplicity. The dynamic multi-overlaid cell technique may be used as a network configuration to avoid narrowband high-power interference. Overlaid cells (e.g., neighboring cell 510) may represent that they are defined in the same geographical location and have similar coverage. In this technique, the overall cell bandwidth may be split into multiple non-overlapping bands, each with its own carrier frequency. Each carrier frequency/band may be assigned to a cell such that no two overlaid cells get the same frequency/band. When the interferer (i.e., RADAR signal 515) is present in the same band as the WTRU, the latter can utilize event A5 545 (i.e., serving cell 505 becomes worse than a certain threshold and neighboring cell (overlaid) 510 become better than a certain threshold) to trigger inter-frequency handover to an overlaid cell of a different carrier and better channel conditions as illustrated in FIG. 5. For example, when a WTRU in a serving cell 505 is impacted by RADAR interference, a received signal in the serving cell is worse than threshold 1 535, and a received signal in the overlaid cell 510 is better than threshold 2 540, the WTRU may then report the A5 handover event 545 and proceed to handover to the overlaid cell 510.

The key idea here is that the definitions of the cell bandwidth and BWPs can be dynamically configured based on changes in the interference characteristics. For example, if the interferer decides to increase its bandwidth and/or change its geographic location (e.g., RADAR), the BS (e.g., gNB) may decide to switch from a single cell spanning the full bandwidth to multiple overlaid cells with non-overlapping sub-bands. The new sub-bands will be defined such that they are non-overlapping with the interferer's bandwidth.

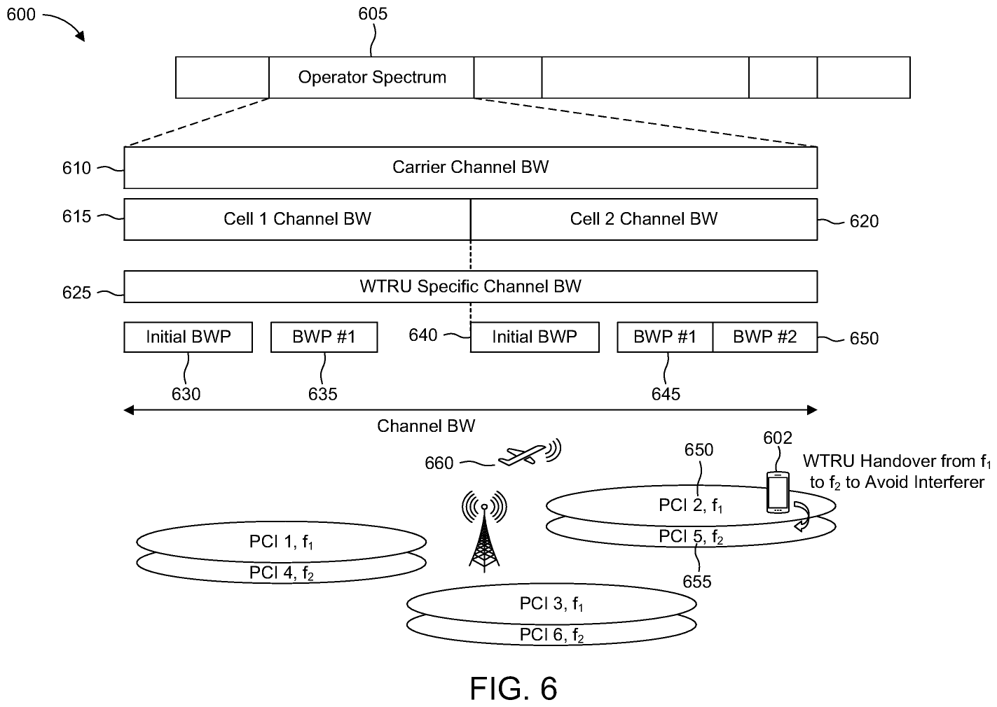

FIG. 6 illustrates an example multiple overlaid cell technique 600 that is used as a network configuration embodiment illustrated in FIG. 5 to avoid interferer, which may be used in combination with any of other embodiments described herein. In this example technique 600, the carder channel bandwidth 610 in the operator spectrum 605 may be split into two (or more) non-overlapping bands: cell 1 channel BW 615 and cell 2 channel BW 620. Each channel BW 615, 620 may be assigned to an overlaid cell. For example, the WTRU specific channel BW 625 may be divided into two portions: one is corresponding to the cell 1 channel BW 615 and the other is corresponding to the cell 2 channel BW 620. The first portion corresponding to the cell 1 channel BW 615 may include an initial BWP 630 and BWP #1 635. The second portion corresponding to the cell 2 channel BW 620 may include an initial BWP 640, BWP #1 645, and BWP #2 650. As illustrated in FIG. 6, a moving interferer 660 (e.g., Airborne Early Warning and Control (AWAC) RADAR) may enter the coverage area of PCI 2 650, which is initially assigned the entire channel BW. The RADR may start operating in the same BW and impact essential signals in the initial BWP. The base station (BS) may detect the RADAR (e.g., either via receiving information from external sensors or by comparing received signal against a certain threshold) and decide to configure a new co-located cell, PCI 5 655, and split the available BW between PCI 2 650 and PCI 5 655. The split may happen such that there are two non-overlapping bands such as cell 1 channel BW 615 and cell 2 channel BW 630, each with its own initial BWP 630, 640 and dedicated BWPs (e.g., BWPs 635, 645, 650) and the BW of the RADAR is entirely outside of the BW of PCI 5 655. The WTRU in PCI 2 650 may be impacted by RADAR interference, report A5 handover event, for example, the A5 event 545 in FIG. 5.

Specifically, PCI 2 650 received signal is worse than threshold 1 (e.g., threshold 1 535 in FIG. 5) and PCI 5 655 received signal is better than threshold 2 (e.g., threshold 2 540 in FIG. 5) and the WTRU may then proceed to handover to PCI 5 655. The overlaid cell 510 may broadcast multiple initial BWPs and the WTRU may use the multiple initial BWPs as described above.

This approach of interference avoidance may be beneficial from a load balancing perspective, compared to a centralized approach in which the BS (e.g., gNB) makes collective decisions to all WTRUs within the interference impacted cell. Decisions on which WTRUs move to which cell are made on a per-WTRU basis, since not all the WTRUs within the impacted cell experience the same level of interference. The impact of bandwidth splitting on achievable throughput can be mitigated via Carrier Aggregation and/or Coordinated Multi-point techniques.

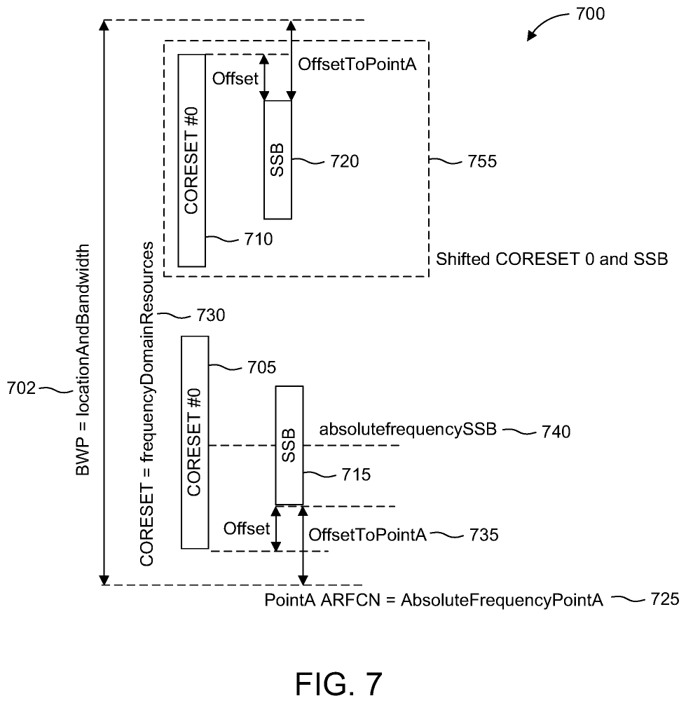

Embodiments for single bandwidth-wide initial BWP are described herein. FIG. 7 illustrates an example single bandwidth-wide initial BWP 700, which may be used in combination with any of other embodiments described herein. As illustrated in FIG. 7, control resource set #0 (CORESET #0) 705 and synchronization signal block (SSB) 715 can be shifted with respect to the upper edge of the BWP 755 in the presence of high-power narrow-band interferer impacting BWP lower edge signals and channels. With a single initial BWP 702 that spans the entire cell bandwidth, the BS (e.g., gNB) may have the capability to move essential channels and signals to avoid high power interference as illustrated in FIG. 7. In this example, essential signals such as CORESET #0 705 and SSB 715 may be moved from the lower edge of the spectrum to the upper edge of the spectrum 755 by applying the same parameters that define the location of each to the other end of the spectrum. As illustrated in FIG. 7, the COREST #0 705 and SSB 715 are moved to the CORESET #0 710 and SSB 720 in the upper edge of the spectrum 755. Here, absoluteFrequencySSB 740 may be the SSB frequency to be used for the cell. This frequency 740 may identify the position of resource element RE=#0 (subcarrier #0) of resource block RB #10 of the SS block. Parameter offsetToPointA 735 may be the offset in PRB between the Point A 725 and the lowest subcarrier of the lowest PRB of the SSB and frequencyDomainResources 730 may be the resource blocks within BWP assigned to WTRU.

Here, it is assumed that the BS (e.g., gNB) has knowledge about the existence of high power narrow band interferer (e.g., RADAR) either via receiving information from external sensors or by comparing received signal against a certain threshold. The BS (e.g., gNB) may indicate to the WTRUs that an interferer exists and it will switch essential signals via MIB signaling. MIB may include information about the location of SSB in frequency domain as depicted below. This may be communicated to the WTRU via ssb-SubcarrierOffset which corresponds to k_ssb (i.e., the frequency domain offset between SSB and the overall resource block grid in number of subcarriers). Moreover, the SIB1 may be transmitted on the PDSCH and be scheduled by downlink control information (DCI) on the PDCCH using CORESET #0 which is defined by MIB parameter pdcch-ConfigS/B1. The spare MIB may be used as shown below to indicate a mirroring in the positions of SSB and CORESET #0 between the two ends of the initial BWP bandwidth to avoid the interferer. In other words, a parameter “SSB-CORESETOShiff” may be defined and may take the value “1” if all offsets happen from point “A” or the value “0” if all offsets happen from the other end of the initial BWP bandwidth. For the latter case, the WTRU may interpret all offsets as moving down in the spectrum from the mirrored point A as opposed to moving up. All other aspect of CORESET #0 and SSB repetition and duration in time in frequency may be interpreted by the WTRU.

MIB ::= SEQUENCE {

| | |
|---|---|
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | INTEGER (0..255), |
| cellBarred | ENUMERATED {barred, notBarred}, |
| intraFreqReselection | ENUMERATED {allowed, notAllowed}, |
| SSB-CORESET0Shift | BIT STRING (SIZE (1)) |

}

Embodiments for WTRU's support of multiple simultaneous initial BWP are described herein.

The WTRU may inform the network of its SSB/Coreset0 shift supportability. The network may optionally enable or disable this feature for the WTRU based on the WTRU capability and the network's requirement. The WTRU may inform the network of its capability via the information message as shown in Table 4 below.

TABLE 4
An example information message for multiple
initial BWPs supportability

| | | | FDD − TDD | FR1 − FR2 |
|---|---|---|---|---|
| Definitions for parameters | Per | M | DIFF | DIFF |
| SSBCoreset0Shift | UE | Yes | No | No |
| Indicates whether | | | | |
| the UE may support | | | | |
| shifting of SSB/Coreset | | | | |
| 0 signals | | | | |

If the WTRU indicates that it does not support this feature, the network may use a configuration such as an initial BWP with a fixed SSB/Coreset 0 location.

In one embodiment, simultaneous operation of multiple initial BWPs can be very effective in mitigating the impact of narrow band interference. For example, an external node may send information characterizing the operation of a narrow band high power interferer to the BS (e.g., gNB). The BS (e.g., gNB) may utilize this information to determine the time and frequency resources that may be impacted by the interference. The BS (e.g., gNB) may determine whether to allocate initial BWPs such that the separation in frequency domain is enough to avoid the impact on the WTRU.

In another embodiment, configuring multiple overlaid cells by splitting existing available BW into multiple frequency orthogonal bands can be used to avoid interference. This technique can be deployed by the service provider if no knowledge about the interferer location in frequency/time is available.

In another embodiment, a single wide-band initial BWP with the flexibility may be used to move essential signals to avoid interference. For example, an external node may send information characterizing the operation of a narrow band high power interferer to a BS (e.g., gNB). The BS (e.g., gNB) may utilize this information to determine the time and frequency resources that may be impacted by the interference. The BS (e.g., gNB) may determine whether to move essential SI signals such that the separation in frequency domain is enough to avoid the impact on the WTRU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor.

Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless transmit/receive unit (WTRU), the method comprising:
receiving, from a base station (BS), configuration information indicating a plurality of initial bandwidth parts (BWPs) that comprise a first initial BWP and a second initial BWP, wherein the first initial BWP and the second initial BWP are separated in a frequency domain to avoid interference on at least one of the plurality of initial BWPs; and
transmitting, based on a failure to decode a first transmission received in the first initial BWP, to the BS, an uplink transmission using the second initial BWP.

2. The method of claim 1, wherein the first initial BWP indicates a location of a first set of resource blocks (RBs) in the frequency domain and the second initial BWP indicates a location of a second set of resource blocks (RBs) in the frequency domain.

3. The method of claim 2, wherein the first set of RBs and the second set of RBs are different.

4. The method of claim 1, wherein the uplink transmission comprises one or more preambles that are sent using a physical random access channel (PRACH).

5. The method of claim 1, further comprising:
receiving, based on failure to decode a second transmission received using the first initial BWP, from the BS, a downlink transmission using the second initial BWP.

6. The method of claim 5, wherein the downlink transmission is a random access response (RAR).

7. The method of claim 1, wherein the configuration information is a system information block 1 (SIB1).

8. The method of claim 1, wherein the first initial BWP comprises at least one of a first initial uplink BWP or a first initial downlink BWP.

9. The method of claim 1, wherein the second initial BWP comprises at least one of a second initial uplink BWP or a second initial downlink BWP.

10. A wireless transmit/receive unit (WTRU) comprising:
a transceiver; and
a processor
wherein the transceiver and the processor are configured to;
receive, from a base station (BS), configuration information indicating a plurality of initial bandwidth parts (BWPs) that comprise a first initial BWP and a second initial BWP, wherein the first initial BWP and the second initial BWP are separated in a frequency domain to avoid interference on at least one of the plurality of initial BWPs; and
transmit, based on a failure to decode a first transmission received in the first initial BWP, to the BS, an uplink transmission using the second initial BWP.

11. The WTRU of claim 10, wherein the first initial BWP indicates a location of a first set of resource blocks (RBs) in the frequency domain and the second initial BWP indicates a location of a second set of resource blocks (RBs) in the frequency domain.

12. The WTRU of claim 11, wherein the first set of RBs and the second set of RBs are different.

13. The WTRU of claim 10, wherein the uplink transmission comprises one or more preambles that are sent using a physical random access channel (PRACH).

14. The WTRU of claim 10, wherein the processor and the receiver are further configured to receive, based on failure to decode a second transmission received using the first initial BWP, from the BS, a downlink transmission using the second initial BWP.

15. The WTRU of claim 14, wherein the downlink transmission is a random access response (RAR).

16. The WTRU of claim 10, wherein the configuration information is a system information block 1 (SIB1).

17. The WTRU of claim 10, wherein the first initial BWP comprises at least one of a first initial uplink BWP or a first initial downlink BWP.

18. The WTRU of claim 10, wherein the second initial BW comprises at least one of a second initial uplink BWP or a second initial downlink BWP.
